(19) United States
(12) Patent Application Publication
(10) Pub. No.: US 2014/0089958 A1
(43) Pub. Date: Mar. 27, 2014

(54) SYSTEMS AND METHODS FOR RECOMMENDING MEDIA ASSETS BASED ON VISUAL ATTRIBUTES

(71) Applicant: United Video Properties, Inc., Santa Clara, CA (US)

(72) Inventors: Michael Nichols, Los Angeles, CA (US); Brian Peterson, Barrington, IL (US)

(73) Assignee: UNITED VIDEO PROPERTIES, INC., Santa Clara, CA (US)

(21) Appl. No.: 13/627,119

(22) Filed: Sep. 26, 2012

(51) Int. Cl. H04N 21/25

(52) U.S. Cl. CPC H04N 21/251
USPC 725/19

(57) ABSTRACT

Methods and systems are described herein for providing improved recommendations of media content by comparing visual attributes of a media asset to visual preferences of a user. A media guidance application may determine the visual attributes, including, but not limited to, the chrominance and luma values of particular pixels in a particular frame or frames of a media asset. The media guidance application compares the determined visual attributes to the visual preferences of a user retrieved from a user profile. Based on the comparison, the media guidance application may recommend the media asset to the user.

### BACKGROUND OF THE INVENTION

The amount of media content currently available to any one user can be substantial. In addition to different television channels, media content may be available through subscription or Video-On-Demand (“VOD”) services or across different platforms such as Internet based sources. Even if a user is aware of all available media content, a user may not know whether or not the particular media content appeals to their interests.

Given the plethora of program options available to a user, it may be difficult for the user to correctly select a program based on the specific interests of the user. In many instances, a user may wish to receive a recommendation for a program, which is likely to be of interest to the user. Typically systems may recommend content based on a particular critical review, actor/actress, and/or title. However, given the sheer number of programs available, even these definitions may be too broad. Therefore, a user may wish to have additional attributes used to further improve recommendations that are tailored to the specific interests of the user.

### SUMMARY OF THE DISCLOSURE

Accordingly, methods and systems are described herein for providing improved recommendations of media content by comparing visual attributes of a media asset to visual preferences of a user. Specifically, a media guidance application determines the visual attributes, including, but not limited to, the chrominance and luma values of pixels in a frame or frames of a media asset. The media guidance application compares the determined visual attributes to the visual preferences of a user retrieved from a user profile. Based on the comparison, the media guidance application may recommend the media asset to the user.

In some embodiments, by aggregating the chrominance values of individual pixels across multiple frames of the media asset, an image processing application may determine the amount and the length of time a particular color is displayed during the media asset. In some embodiments, the image processing application may be incorporated into the media guidance application or may be a separate application that transmits the data about the color to the media guidance application. Using proportional analysis, the media guidance application may determine a ratio of the color to other colors displayed during the media asset. Based on the ratios for each color to the remaining colors, the media guidance application may determine a color palette used by the media asset. Likewise, by processing luma values of particular pixels across multiple frames of the media asset for descriptive statistics, the media guidance application may determine, for example, an average brightness level and/or the number of sudden brightness changes (e.g., indicating frequent flashing screens or explosions) of the media asset. The media guidance application may then compare the determined visual attributes to visual preferences from a user profile.

In some embodiments, data regarding the visual attributes of a media asset (e.g., the chrominance values of pixels in a frame of a media asset) may be transmitted with a media asset and received by the media guidance application implemented on a user equipment device. In some embodiments, the data may be generated by a media guidance application, either on local or remote equipment, by processing the pixels of each frame of the media asset.

In some embodiments, the media guidance application may determine the visual attributes of media assets typically viewed by a user to develop the visual preferences of the user. For example, if several media assets that are viewed by the user have an average luma value below a particular threshold, the media guidance application may recommend only media assets with an average luma value below the threshold.

In some embodiments, the media guidance application may extrapolate additional information about the media asset based on the visual attributes. For example, after determining the color palette of a particular media asset, the media guidance application may compare the determined color palette to a database of color palettes associated with other media assets. The comparison may reveal that media assets with the color palette of the media asset are typically of a particular animation style (e.g., anime). Furthermore, the visual preferences may indicate that the user enjoys a particular animation style.

Likewise, after determining the average luma value of a particular media asset is low (e.g., indicating that the media asset is dark), the media guidance application may compare the determined value to a database of average luma values associated with other media assets. The comparison may reveal that media assets with the determined value are typically of a particular mood (e.g., somber) and/or of a particular genre (e.g., horror and/or suspense). Furthermore, a comparison of the visual attributes with the visual preferences may further indicate that the user enjoys media assets with the same mood and/or genre.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of two frames of two media assets in which the visual attributes of each frame have been analyzed in accordance with some embodiments of the disclosure;

FIG. 2A shows an illustrative media guidance application that may be used to recommend media assets in accordance with some embodiments of the disclosure;

FIG. 2B shows an illustrative media guidance application that may be used to recommend media assets and further enable a user to request recommendations based on an analysis of the visual attributes of a media asset in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5A is an illustrative data structure of data that accompanies a media asset that describes the visual attributes of the media asset in accordance with some embodiments of the disclosure;

FIG. 5B is an illustrative array of data that that describes the visual attributes of a media asset in accordance with some embodiments of the disclosure;

FIG. 6A is a chromaticity diagram, which may be used by the media guidance application to determine a value associated with a visual attribute in accordance with some embodiments of the disclosure;

FIG. 6B is an image histogram, which may be used by the media guidance application to determine the visual attributes of a media asset in accordance with some embodiments of the disclosure;

FIG. 7 is a flowchart of illustrative steps for determining visual attributes associated with pixels in a frame of a media asset in accordance with some embodiments of the disclosure; and

FIG. 8 is a flowchart of illustrative steps for determining whether or not to recommend a media asset to a user based on a comparison of visual attributes of a media asset and the visual preferences of a user in accordance with some embodiments of the disclosure.

### DETAILED DESCRIPTION OF DRAWINGS

The amount of content available to users in any given content delivery system can be substantial. Consequently, many users desire a form of media guidance through an interface that allows users to efficiently navigate content selections and/or easily receive content recommendations for content the user may enjoy. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as content recommendations, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

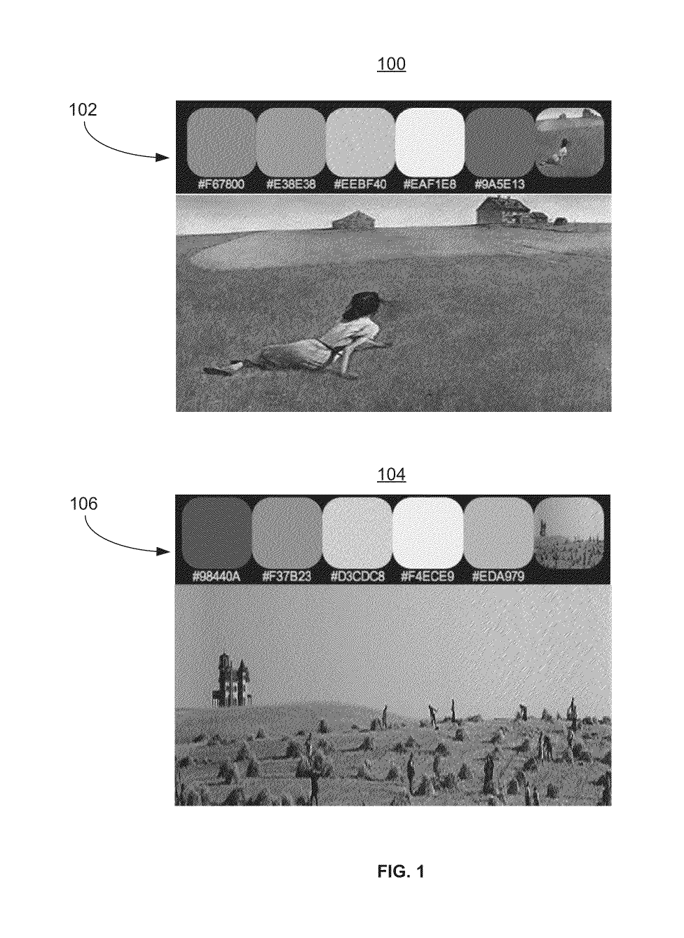

A media guidance application may provide content recommendations to users. FIG. 1 shows an illustrative example of two frames of two media assets in which the visual attributes of each frame have been analyzed in order to provide such content recommendations. As described herein, a media guidance application of this disclosure may provide improved recommendations of media content by comparing visual attributes of a media asset to visual preferences of a user.

As used herein, “visual attributes” refer to characteristics which define the appearance or visual qualities of one or more pixels in a frame of a media asset. Visual attributes may include, but are not limited to, data related to color, including chromaticity (also referred to as chrominance in video systems), hue, colorfulness, saturation, chroma, intensity, and/or excitation purity, and luminance (also referred to as luma in video systems) in a media asset. For example, the visual attributes of a media asset may include any measurable visual quality that may have an effect on how the media asset is displayed to a user.

In FIG. 1, display 100 and 104 represent a frame from a first media asset and a second media asset, respectively. The dominant colors in each frame are shown in array 102 and 106, respectively, identified in a hexadecimal format (a hex triplet). The hexadecimal format may represent a value associated with a visual attribute or attributes. It should be noted that the identification and classification of visual attributes may be done using any metric, measurement, and/or classification scheme. For example, a color may be classified in any suitable manner, including, but not limited to, an RGB triplet, X11 color names, HTML4, CMYK color model, or other mathematical coordinates on a color space as discussed below. Similarly, other visual attributes as discussed herein may be measured and classified under any standard or suitable method.

In some embodiments, the media guidance application may determine a visual preference of a user, which may be compared to the visual attributes of a media asset. As used herein, a “visual preference” refers to any preference related to the presence of a visual attribute or a value of a visual attribute in a media asset. For example, a user may prefer media assets with a particular color palette (i.e. a finite set of colors that are predominant in a media asset). For example, a user may enjoy the color palette of the media asset in display 100. The media guidance application may use proportional analysis to determine a ratio of the one color (or any visual attribute) to other colors (or any other visual attribute) displayed during the media asset. Based on the ratios of each color to every other color, the media guidance application may determine the particular color palette used by the media asset. In some embodiments, the media guidance application may determine that display 104 has a similar color palette to display 100, and may therefore recommend the media asset to the user.

For example, a media guidance application may determine the predominant chrominance value or values in a media asset. The media guidance application may cross-reference the determined chrominance value or values with a database of chrominance values of other media assets to determine other media assets in which the same chrominance value or values are predominant. The media guidance application may then determine, passively (e.g., monitoring the length of time a user accesses a particular media asset and based on that length determine whether or not the user enjoyed the media asset) or actively (e.g., requesting the user rank the media asset or otherwise indicate whether or not the user enjoyed the media asset), whether or not a user enjoys the determined media assets. If so, the media guidance application may recommend the media asset.

In another example, the media guidance application may track the visual attributes of media assets accessed by a user. The media guidance application may extrapolate values of particular visual attributes of media assets that are enjoyed (e.g., as determined above) by the user. The media guidance application may then search for other media assets with matching visual attributes. Upon locating the media assets with matching visual attributes, the media guidance application may recommend the located media assets to the user.

In some embodiments, one or more visual attributes, or an amount, duration, frequency, etc. of the visual attribute, may be used by the media guidance application to determine additional characteristics of the media asset. For example, the media guidance application may use data regarding one or more visual attributes to determine a particular genre, mood, and/or animation style associated with the media asset. The media guidance application may then determine whether or not a user enjoys that particular genre, mood, and/or animation style. If so, the media guidance application may recommend the media asset to the user.

For example, a media guidance application may determine the average luma value in a media asset. The media guidance application may cross-reference the determined average luma value with a database of luma values of media assets. The database may indicate that media assets containing the determined average luma value are typically of a particular genre, mood, and/or animation style. For example, the luma value of a media asset may be low indicating that the movie is typically displaying a dark screen, which may indicate (e.g., according to a database) that the media asset is of the horror genre, a genre in which media assets typically display a dark screen.

The media guidance application may then reference a user profile of the user to determine whether or not the user enjoys media assets in the horror genre. Based on data in the user profile, the media guidance application may determine whether or not to recommend the media asset to the user. As used herein, a “user profile” may be any collection of data relating to the preferences of a user in regards to media assets or visual attributes.

In some embodiments, the user profile may contain an aggregation of data based on the viewing habits of a user. For example, the media guidance may determine the visual attributes of media assets typically viewed by a user to develop the visual preferences of the user. For example, if several media assets that are viewed by the user have an average luma value below a particular threshold, and the user views a particular (e.g., a threshold) number of these media assets, or the user views these media assets for a particular (e.g., a threshold) amount of time, the media guidance application may determine the user prefers darker media assets. Data in the user profile may then be used to recommend media assets. For example, the media guidance application may recommend only media assets with an average luma value below the threshold.

In some embodiments, by aggregating the chrominance values of individual pixels across multiple frames of the media asset, the media guidance application may determine the amount and the length of time a particular visual attribute occurs during the media asset. For example, the media guidance application may track not only the number of pixels of a particular frame that have a particular visual attribute, but also the number of pixels across all frames in the media asset that have a particular visual attribute.

In addition, the media guidance may compare the visual attributes of one frame of a media asset to another frame of the media asset. For example, by processing the luma values of particular pixels across multiple frames of the media asset for descriptive statistics, the media guidance application may determine, for example, an average brightness level and/or the number of sudden brightness changes (e.g., indicating frequent flashing screens or explosions) from one frame of the media asset to a subsequent frame of the media asset. The media guidance application may then compare the descriptive statistics to a database of descriptive statistics of other media assets. Based on the comparison of the descriptive statistics for the media asset to the descriptive statistics of other media assets, the media guidance application may extrapolate additional information about the media asset. For example, if the media asset has a particular number (e.g., a threshold number) of sudden brightness changes, the media guidance application may determine the media asset is of a particular genre (e.g., action) or animation style (e.g., anime), which typically feature flashing screens and bright, contrasting colors. The media guidance application may then reference the user profile of the user to determine whether or not the user enjoys anime media assets. Based on data in the user profile, the media guidance application may determine whether or not to recommend the media asset to the user.

In some embodiments, data regarding the visual attributes of a media asset (e.g., the chrominance values of pixels in a frame of a media asset) may be transmitted with a media asset (e.g., as metadata) and received by the media guidance application implemented on a user equipment device. In some embodiments, the data may be generated by a media guidance application, either on local or remote equipment, by processing the pixels of each frame of the media asset. For example, the media guidance application may include image processing capabilities such that the media guidance application may receive an input of an image (e.g., a frame of a media asset) and output a set of characteristics or parameters related to the image. The media guidance application may use any standard image and/or signal processing techniques.

In some embodiments, image processing may include one or more samplings at a time. As used herein, a sampling may include one or more pixels or frames. For example, a sampling may include a group of pixels (e.g., that define a distinct region of the frame or an entity on the frame) or a group of frames (e.g., that define a predetermined number of frames or a particular scene of a media asset). It should be noted that as used in the context of image processing throughout this disclosure systems and methods described in relation to samples of pixels may also be applied to, for example, single-color regions (e.g., subpixels) or any other input used by an image sensor to convert an optical image into an electronic signal or vice versa. Furthermore, the use of pels, bytes, bits, dots, spots, etc., which in some context may be synonymous with samples or pixels is also contemplated by this disclosure. In addition, throughout this disclosure the term “frame” should be understood to apply to conventional film frames, video frames, and/or digital frames and such frames should be understood to include the still images, when shown in series, that make up a media asset.

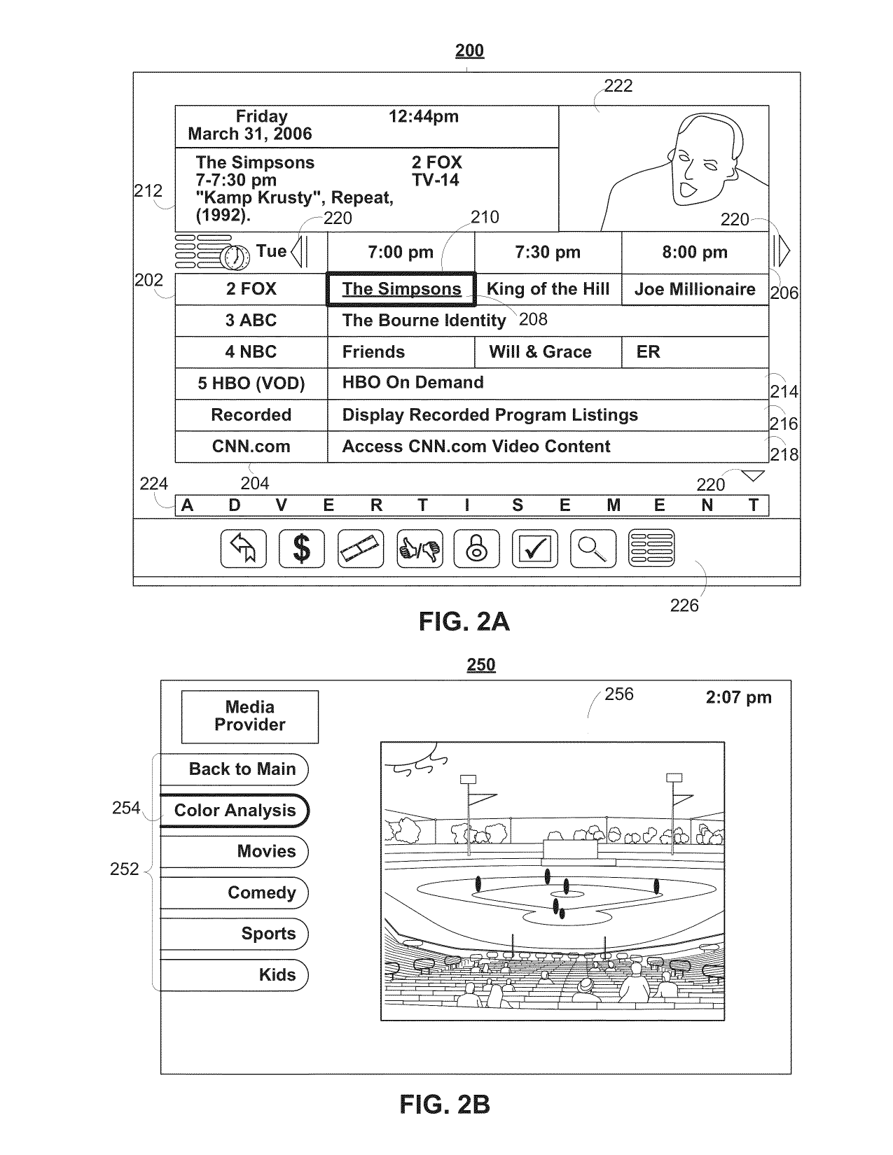

FIGS. 2A-B show illustrative display screens that may be used to provide media guidance data. The display screens shown in FIGS. 2A-B may be implemented on any suitable user equipment device or platform. While the displays of FIGS. 2A-B are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 2A shows illustrative grid program listings display 200 arranged by time and channel that also enables access to different types of content in a single display. Display 200 may include grid 202 with: (1) a column of channel/content type identifiers 204, where each channel/content type identifier (which is a cell in the column) identifies a different channel or content type available; and (2) a row of time identifiers 206, where each time identifier (which is a cell in the row) identifies a time block of programming. Grid 202 also includes cells of program listings, such as program listing 208, where each listing provides the title of the program provided on the listing's associated channel and time. With a user input device, a user can select program listings by moving highlight region 210. Information relating to the program listing selected by highlight region 210 may be provided in program information region 212. Region 212 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet website or other Internet access (e.g., FTP).

Grid 202 may provide media guidance data for non-linear programming including on-demand listing 214, recorded content listing 216, and Internet content listing 218. A display combining media guidance data for content from different types of content sources is sometimes referred to as a “mixed-media” display. Various permutations of the types of media guidance data that may be displayed that are different than display 200 may be based on user selection or guidance application definition (e.g., a display of only recorded and broadcast listings, only on-demand and broadcast listings, etc.). As illustrated, listings 214, 216, and 218 are shown as spanning the entire time block displayed in grid 202 to indicate that selection of these listings may provide access to a display dedicated to on-demand listings, recorded listings, or Internet listings, respectively. In some embodiments, listings for these content types may be included directly in grid 202. Additional media guidance data may be displayed in response to the user selecting one of the navigational icons 220. (Pressing an arrow key on a user input device may affect the display in a similar manner as selecting navigational icons 220.)

Display 200 may also include video region 222, advertisement 224, and options region 226. Video region 222 may allow the user to view and/or preview programs that are currently available, will be available, or were available to the user. The content of video region 222 may correspond to, or be independent from, one of the listings displayed in grid 202. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 224 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 202. Advertisement 224 may also be for products or services related or unrelated to the content displayed in grid 202. Advertisement 224 may be selectable and provide further information about content, provide information about a product or a service, enable purchasing of content, a product, or a service, provide content relating to the advertisement, etc. Advertisement 224 may be targeted based on a user's profile/preferences, monitored user activity, the type of display provided, or on other suitable targeted advertisement bases.

While advertisement 224 is shown as rectangular or banner shaped, advertisements may be provided in any suitable size, shape, and location in a guidance application display. For example, advertisement 224 may be provided as a rectangular shape that is horizontally adjacent to grid 202. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 226 may allow the user to access different types of content, media guidance application displays, and/or media guidance application features. Options region 226 may be part of display 200 (and other display screens described herein), or may be invoked by a user by selecting an on-screen option or pressing a dedicated or assignable button on a user input device. The selectable options within options region 226 may concern features related to program listings in grid 202 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

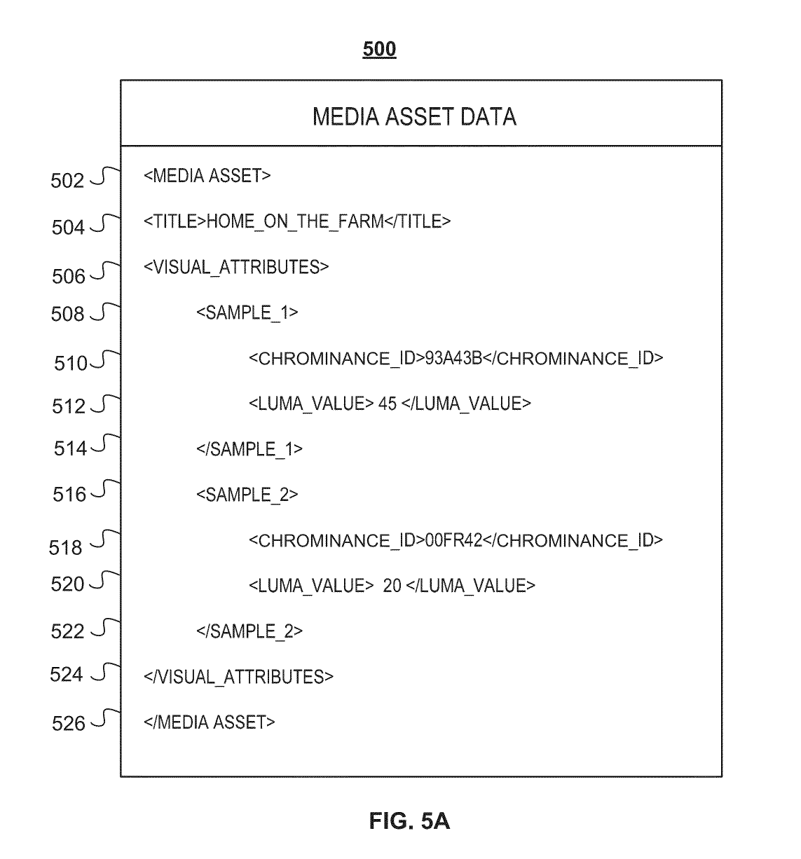

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other websites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

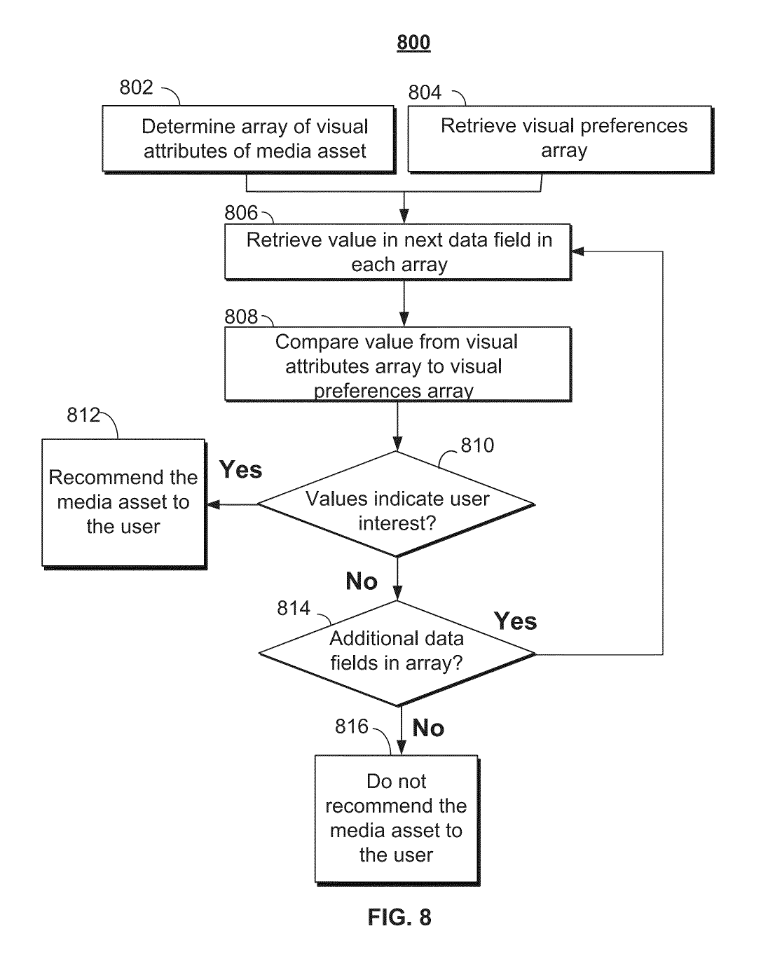

Another display arrangement for providing media guidance is shown in FIG. 2B. Video display 250 includes selectable options 252 for content information organized based on content type, genre, and/or other organization criteria. For example, in some embodiments, activation of selectable options 252 may allow a user to receive media asset recommendations from the media guidance application. In display 250, color analysis option 254 is selected, thus providing listings 256, which is recommended based on a comparison of the visual attributes of listing 256 and the visual preferences of the user (e.g., as described in process 800 (FIG. 8)). In display 250 the listings may provide textual descriptions of one or more listings (e.g., summaries, titles, cast bios, etc.) or may provide graphical images including cover art, still images from the content, video clip previews, live video from the content, or other types of content that indicate to a user the content being described by the media guidance data in the listing.

In some embodiments, the listings shown in display 250 may be of different sizes (e.g., indicating a level of recommendation), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

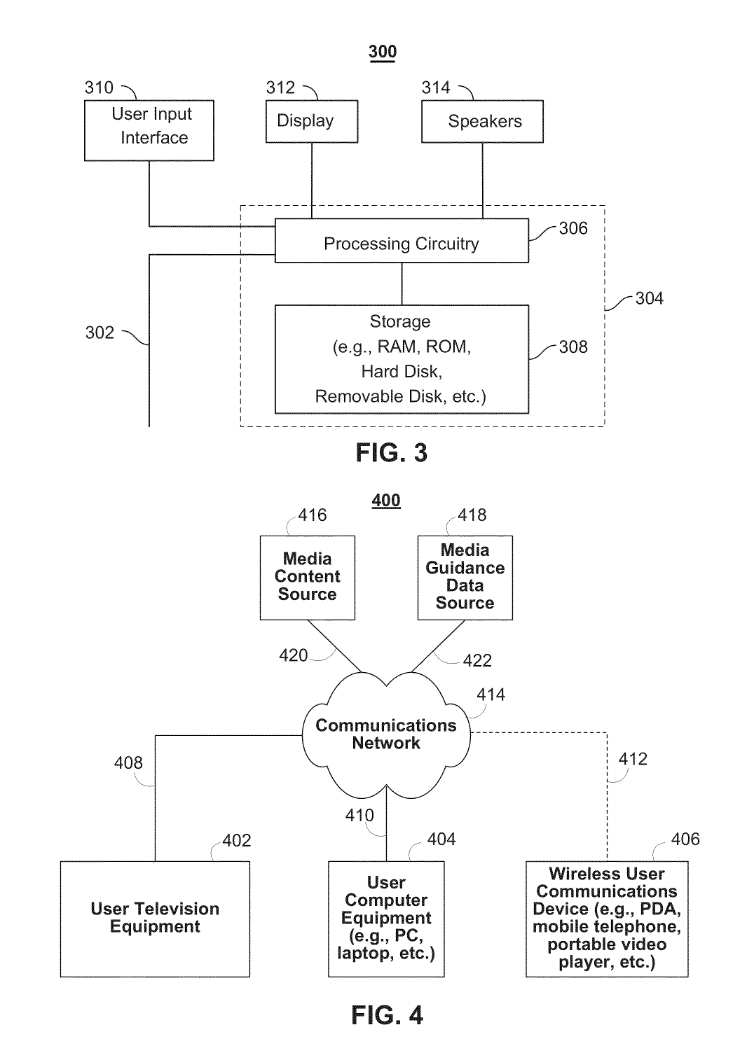

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiples of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server.

Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment device 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment device 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

In some embodiments, control circuitry 304 may perform image processing/color analysis as described throughout this disclosure. Furthermore, it should be noted that the user equipment device 300 of FIG. 3 or any of the devices described in system 400 of FIG. 4 may perform the image processing/color analysis. For example, in some embodiments, the media guidance application may incorporate an image processing application. Therefore, it should be understood that any device or location described within the disclosure upon which the media guidance application may be implemented, an image processing application may also be implemented. Additionally or alternatively, if the image processing application is a separate application from the media guidance application, the image processing application and the media guidance application may transmit or receive data from each other from any location and/or device accessible to the communications network 414 (FIG. 4). For example, the media guidance application may be implemented on one or more devices in system 400 (e.g., user equipment 402, 404, and/or 406) and the image processing application may be implemented on media content source 416, media guidance data source 418, and/or any other device accessible from the communications network 414 (e.g., an image processing server (not shown)). The media guidance application and the image processing application may then communicate along communication paths (as described below) to transmit and/or receive data. It should be noted that all the embodiments and processes described herein as being implemented using the guide may be implemented by the image processing application and vice versa.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment 402, 404, and 406 are shown as through communications network 414, in some embodiments, sources 416 and 418 may communicate directly with user equipment 402, 404, and 406 via communication paths (not shown) such as those described above in connection with paths 408, 410, and 412.

Media content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Media content source 416 may be the originator of content (e.g., a television broadcaster, a Webcast provider, etc.) or may not be the originator of content (e.g., an on-demand content provider, an Internet provider of content of broadcast programs for downloading, etc.). Media content source 416 may include cable sources, satellite providers, on-demand providers, Internet providers, over-the-top content providers, or other providers of content. Media content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with media content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e. applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

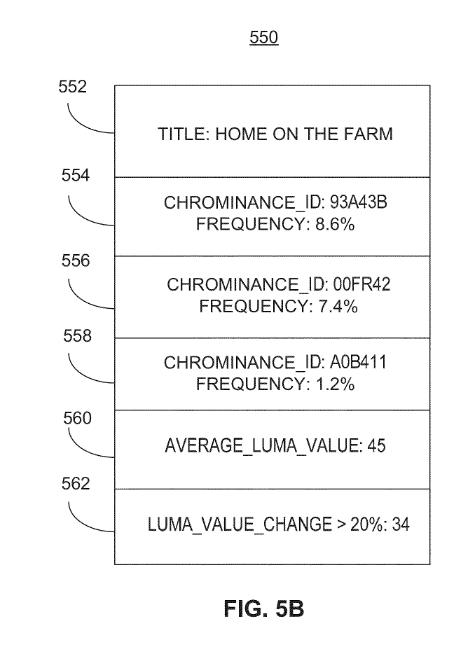

FIG. 5A is an illustrative data structure of data that accompanies a media asset that describes the visual attributes of the media asset in accordance with some embodiments of the disclosure. For example, in some embodiments, data describing the visual attributes may be transmitted with the media asset. A data structure, as shown in FIG. 5A, may include various lines of data that describe different visual attributes of a media asset. Furthermore, the data structures may include various samplings that describe distinct portions of a frame (e.g., one or more pixels) or of a media asset (e.g., a particular number of frames, a scene, or a segment of the play length of the media asset). It should be noted that data structure 500 as shown in FIG. 5A is an exemplary data structure and is not intended to be limiting. In some embodiments, additional or fewer visual attributes may be described in a data structure similar to data structure 500.

It should also be noted that any of the devices in FIGS. 3 and 4 may be used to transmit, process, receive and/or store data structure 500 or any line included in data structure 500. For example, in some embodiments, data structure 500 may be transmitted with a media asset (e.g., as metadata) from media content source 416 (FIG. 4) to user equipment 402, 404, and/or 406 (FIG. 4) via the communications network 414 (FIG. 4). Furthermore, a media guidance application implemented on user equipment 402, 404, and/or 406 (FIG. 4) may receive, process, and/or store data structure 500. In some embodiments, processing circuitry 306 (FIG. 3) may be used to process data structure 500. For example, processing circuitry 306 (FIG. 3) may process data structure 500 to issue instructions to the media guidance application as data structure 500 is received.

Data structure 500 includes multiple lines of codes. Line 502 indicates to the media guidance application that line 502 through line 526 of the data structure relates to a media asset. For example, in some embodiments, data regarding the media asset may be transmitted as guidance data from media guidance data source 418 (FIG. 4) separately from the media asset, which may be sent from media content source 416 (FIG. 4). Line 502 may indicate to the media guidance application that data structure 500 relates to a media asset as opposed to other guidance application features as described above.

Line 504 indicates to the media guidance application the title of the media asset to which data structure 500 relates. For example, in some embodiments, data structure 500 may be transmitted prior to a user accessing a media asset. The information included in data structure 500 may be stored locally (e.g., on user equipment 402, 404, and/or 406 (FIG. 4)) in a database. In some embodiments, the database may be referenced whenever the media guidance application needs to determine the visual attributes of a media asset.

Line 506 indicates to the media guidance application that line 506 through line 524 relates to visual attributes of the media asset. In some embodiments, the visual attributes described in data structure 500 may include any of the visual attributes described within this disclosure (e.g., contrast, hue, saturation, etc.). The information relating to the visual attributes is divided into individual samplings. For example, line 508 through line 514 describes a first sample and line 516 through line 522 describes a second sample. In data structure 500, each sample includes information on the chrominance (e.g., line 510 and line 518, respectively) and the luma value (e.g., line 512 and line 520, respectively) for each sample.

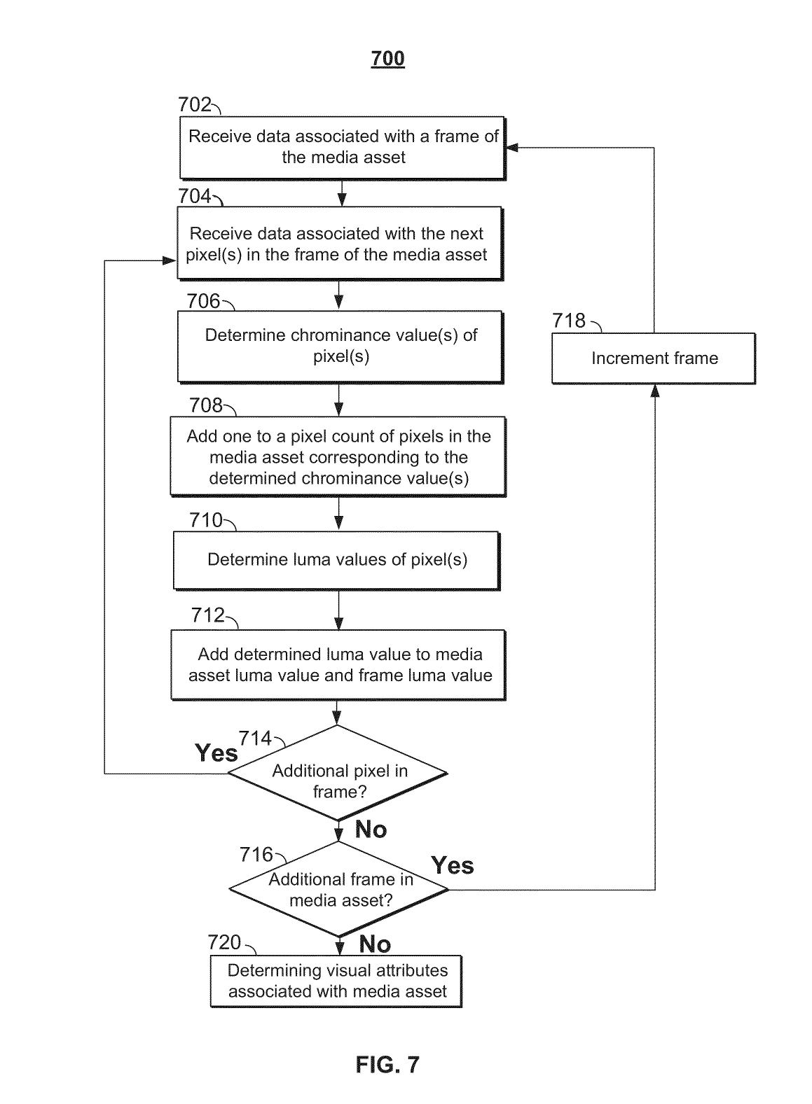

As described in depth in relation to FIG. 7 below, and as described above, visual attributes of a sample may be aggregated (e.g., in an array as shown in FIG. 5B) or otherwise processed to determine visual attributes for a frame, group of frames, or a media asset. The aggregated visual attributes may then be used to recommend media assets as described in FIG. 8 below. For example, the data included in one or more data structures 500 may be combined at user equipment 402, 404, and/or 406 (FIG. 4). The combined information may be used to generate an array of data that describes the visual attributes of a media asset (e.g., as shown in array 550 of FIG. 5B below).

FIG. 5B is an illustrative array of data that describes the visual attributes of a media asset in accordance with some embodiments of the disclosure. For example, in some embodiments, data, in a file such as array 550, describing the visual attributes may be transmitted with the media asset (e.g., as metadata or a separate file) and/or stored (e.g., in a database) for use by the media guidance application. An array, as shown in FIG. 5B, may include various data fields that describe different visual attributes of a media asset. Furthermore, the array may include information on various samplings and/or aggregated information from the samplings about distinct portions of a frame, frames, or media asset. It should be noted that array 550 as shown in FIG. 5B is an exemplary data array and is not intended to be limiting. In some embodiments, additional or fewer visual attributes may be described in data fields similar to the data fields of array 550.

It should also be noted that any of the devices in FIGS. 3 and 4 may be used to transmit, process, receive and/or store array 550 or any data field included in array 550. For example, in some embodiments, array 550 may be transmitted in a file accompanying a media asset from media content source 416 (FIG. 4) to user equipment 402, 404, and/or 406 (FIG. 4) via the communications network 414 (FIG. 4). Furthermore, a media guidance application implemented on user equipment 402, 404, and/or 406 (FIG. 4) may receive, process, and/or store array 550. In some embodiments, processing circuitry 306 (FIG. 3) may be used to process array 550. For example, processing circuitry 306 (FIG. 3) may process array 550 to issue instructions to the media guidance application as array 550 is received from a remote device and/or retrieved from storage. In some embodiments, for example, as described in relation to FIG. 8 below, the media guidance application may compare array 550 to an array of visual preferences in, for example, a user profile.

Array 550 may include various data fields. The data fields of array 550 may be used to describe visual attributes of a sampling of pixels on a frame or may be used to describe aggregated visual attributes (e.g., of a frame, a group of frames, a scene, a segment, or an entire media asset). Data field 554, 556, and 558 each describe the frequency of a particular chrominance (e.g., as identified by a hexadecimal number) in a sampling of the media asset. Information found in array 550 (e.g., as expressed as values in a data field) may be compared to visual preferences by the media guidance application to determine whether or not to recommend a media asset to a user.

For example, the frequency of a particular chrominance may be used by the media guidance application to analyze the ratio of one color to another color in the media asset. By performing a proportional analysis, the media asset may determine a particular color palette used by the media asset. The color palette, and information regarding the visual preferences of the user, may then be used to recommend (or not recommend) the media asset as described in FIG. 8 below.

Furthermore, information received in array 550 (e.g., as expressed as values in a data field) may be compared to a database to determine additional information about a media asset. For example, data field 560 indicates the average luma value of the media asset. The media guidance application may recognize this luma value as indicating the media asset is “bright,” and, therefore, is likely to have an upbeat and positive mood. In another example, upon cross-reference of this value into a database of luma values for particular media assets, the database may indicate that media assets of this particular luma value are typically romantic comedies. The media guidance application may then determine whether or not the user enjoys romantic comedies (e.g., either actively or passively as described above).

Data field 562 indicates the number of times the luma value changed in an amount greater than twenty percent from one frame to the next (e.g., indicating an explosion or flashing light). In some embodiments, the media guidance application may compare this visual attribute to the visual preferences of a user to determine whether or not the user typically enjoys media assets containing this visual attribute. For example, explosions and/or flashing lights may indicate a particular genre (e.g., action) or a particular type of animation (e.g., anime) and by comparing the visual attributes of the media asset to the visual preferences of the user, the media asset may determine whether or not to recommend this media asset to the user (e.g., as described below).

In some embodiments, the media guidance application compares data values of a particular type (e.g., a particular visual attribute of a media asset to a corresponding visual preference) as described in relation to FIG. 8 below. To compare the data values, the media guidance application may use multiple types of object recognition, including fuzzy logic. For example, the particular information may be found in a data field that may be a textual data field. Using fuzzy logic, the system may determine two fields to be identical (or different) even though the substance of the data field (e.g., two different spellings) is not identical. In some embodiments, the media guidance application may analyze corresponding data fields for particular values or text. The data fields could be associated with visual attributes, categories, genres, series, episodes, products, traits, ratings, targeted audiences, textual descriptions, or any other suitable indicator that may be used to determine a category, genre or interest of the user. Furthermore, the data fields could contain values (e.g., the data fields could be expressed in digits, binary code, or any other suitable code or programming language). Other suitable methods for comparing data are also contemplated by this disclosure.

Furthermore, when comparing data fields (e.g., a data field of a visual attributes array to a visual preferences array as described below in relation to FIG. 8), or values in a data field, the media guidance application may include a particular range or threshold that indicates that two values are related. For example, if the number of luma changes in the first data field of an array (e.g., the visual attributes array) is equal to ten, the media guidance application may determine that another data field (e.g., the visual attributes array) is similar, or matches, the first data field if it contains a value within a certain range of the first value (e.g., plus/minus two). Therefore, if the other data field has a value of eight to twelve, the media guidance application may determine that the two data fields are similar or match. It should be noted that the media guidance application may determine a range that indicates a value is similar, or matches, for any visual attribute. For example, a particular color may have other colors or shades that are determined to be within a particular range (e.g., within a particular distance on diagram 600 (FIG. A)). As described in relation to FIG. 8 below, determining that two data fields match may form the basis of whether or not a media asset is recommended to a user.

In another example, when comparing data fields (e.g., a data field of a visual attributes array to a visual preferences array as described below in relation to FIG. 8), or values in a data field, that describe a position on an RGB color space (e.g., diagram 600 below), the media guidance application may determine that values within a particular distance from each other are similar and/or constitute a match for the purposes of recommending media assets as described in FIG. 8 below. For example, if the first data field of an array (e.g., the visual attributes array) indicates that the most prevalent color in the media asset has a coordinate of (0.1500, 0.0600), the media guidance application may determine that any point within a particular, or threshold, distance (e.g., +/−0.02 of either coordinate value is similar to/and matched to the value in the first data field. For example, if the threshold distance is +/−0.02, then a coordinate value of, including and not limited to, (0.1700, 0.0600), (0.1300, 0.0600), (0.1500, 0.0800), and (0.1500, 0.0400) would all be considered similar and/or matched.

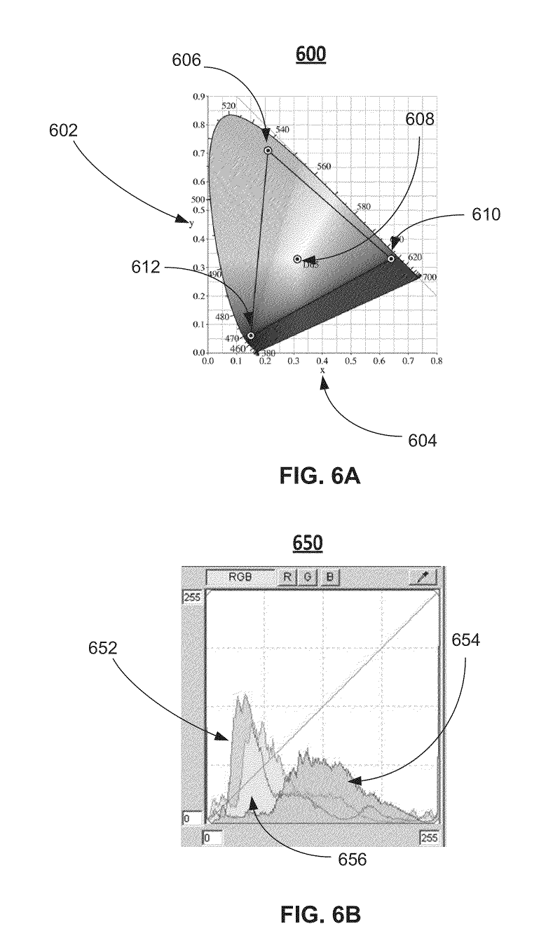

As described above, the media guidance application of this disclosure may include image processing capabilities, include an image processing application, and/or receive data regarding the visual attributes of a media asset from an image processing application. FIGS. 6A-B describes various functions of an image processing application in relation to a media guidance application of this disclosure. For simplicity, FIGS. 6A-B will be described in reference to a media guidance application performing the image processing (e.g., via an image processing application incorporated into the media guidance application). It should be noted, however, that the image processing may also occur via the other arrangements described in this paragraph.

FIG. 6A is a chromaticity diagram, which may be used by the media guidance application to determine a value associated with a visual attribute in accordance with some embodiments of the disclosure. To assign values and/or compare visual attributes to visual preferences, the media guidance application may consult standard classification metrics, systems, or standards. FIG. 6A illustrates an example of one metric that may be used to assign a value to a visual attribute. Diagram 600 shows a CIE 1931 XY chromaticity diagram featuring an RGB color space, which, in some embodiments, may be used by the media guidance application to assign a value to a visual attribute (e.g., the chrominance of a pixel in a media asset).

In diagram 600, axis 602 and axis 604 form a grid through which numerical coordinates can be used to express different chrominance values. Point 606, which indicates the primary color green, is located at (0.2100, 0.7100) of the grid. Point 608, which indicates the color white, is located at (0.3127, 0.3290) of the grid. Point 610, which indicates the primary color red, is located at (0.6400, 0.3300) of the grid. Point 612, which indicates the primary color blue, is located at (0.1500, 0.0600) of the grid. Various other colors may be expressed as points on the grid. In some embodiments, the media guidance application may express visual attributes, (e.g., chrominance) according to values found in diagram 600.

In some embodiments, alternative and/or additional systems or schemes as discussed above may also be used to define the visual attributes of the media asset. In addition, corresponding systems and schemes may be used to define other visual attributes as described throughout this disclosure. It should be noted that any of the devices in FIGS. 3 and 4 may process a media asset according to the systems or schemes discussed above. In some embodiments, the systems or schemes may be transmitted to a local device (e.g., user equipment 402, 404, and/or 406). The systems or schemes may then be used to define the visual attributes of media assets accessed by a user. In some embodiments, the system or scheme may be located on a database located locally (e.g., on user equipment 402, 404, and/or 406) or remotely (e.g., on media guidance data source 418 and/or any device accessible via communications network 414) for reference by the media guidance application. Furthermore, the values and/or additional information needed to apply one or more systems or schemes may be similarly stored on local and/or remote devices.

FIG. 6B is a image histogram, which may be used by the media guidance application to determine the visual attributes of a media asset in accordance with some embodiments of the disclosure. Diagram 650 shows the graphical representation of the chrominance distribution in a frame of a media asset. The horizontal axis of the diagram represents the chrominance variations, while the vertical axis represents the number of pixels of that particular chrominance in the media asset. The left side of diagram 650 indicates media assets with darker colors (e.g., blacks and dark grays). The right side of diagram 650 indicates media assets with brighter colors (e.g., whites and other light colors).

Media assets 652, 654, and 656 all have different chrominance variations as shown by diagram 650. Media asset 652 and media asset 656 have darker colors as indicated by the spikes on the left side of diagram 650, whereas media asset 654 has lighter colors as indicated by its concentration in the center of diagram 650. The media guidance application may use this information to make content recommendations to a user. For example, if the user indicates a preference for media asset 652 (e.g., either actively or passively as described above) or the visual preferences of the user indicate a preference for media assets with a darker colors (e.g., indicating a particular mood or genre), the media guidance application may be more likely to recommend media asset 656 than media asset 654 to the user as the particular visual attribute measured by diagram 650 indicates media asset 656 is darker and more similar to media asset 652 than media asset 654.

In some embodiments, alternative and/or additional visual attributes may be processed using corresponding image histograms. Furthermore, the image histograms for one or more individual samplings and/or frames of a media asset may be aggregated as discussed above to produce an aggregated image histogram for a visual attribute. It should be noted that any of the devices in FIGS. 3 and 4 may process a media asset in order to produce an image histogram as discussed above. In some embodiments, the image histogram may be transmitted to a local device (e.g., user equipment 402, 404, and/or 406) with a media asset for use by the media guidance application. The image histograms may then be used to define the visual attributes of media assets accessed by a user (e.g., to provide recommendations of media content as discussed in FIG. 8 below). In some embodiments, the image histograms for each media asset may be located on a database, either locally (e.g., user equipment 402, 404, and/or 406) or remotely (e.g., on media guidance data source 418 and/or any device accessible via communications network 414), and may be referenced by the media guidance application. Furthermore, the values and/or additional information needed to apply one or more of the image histograms may be similarly stored on local and/or remote devices.

FIG. 7 is a flowchart of illustrative steps for determining visual attributes associated with pixels in a frame of a media asset in accordance with some embodiments of the disclosure. Process 700 describes steps taken by the media guidance application to determine the visual attributes associated with a media asset.

It should be noted that the equipment or devices as shown and described in relation to FIGS. 3-4 may be used to perform any step in process 700. For example, in some embodiments, the media guidance application may be located on user equipment 402, 404, and 406 (FIG. 4), media content source 416 (FIG. 4), media guidance data source 418 (FIG. 4) and/or any device accessible via communications network 414 (FIG. 4), and the media guidance application may instruct the equipment or devices using processing circuitry (e.g., processing circuitry 306 (FIG. 3)). Furthermore, it is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

It should be noted that process 700 describes determining the visual attributes of chrominance and luma in a media asset; however, any other visual attribute as described in this disclosure may be determined using process 700 as well. The determination of chrominance and luma is meant as exemplary only and should not be taken to be limiting.

At step 702, the media guidance application receives data associated with a frame of the media asset accessed on user equipment (e.g., user equipment 402, 404, and/or 406 (FIG. 4)). For example, the media guidance application may receive a data structure (e.g., data structure 500), which describes the visual attributes of particular pixels of a frame of a media asset. Process 700 uses this information, as described in the steps below to determine the visual attributes of the entire media asset at step 720.

At step 704, the media guidance application receives data associated with the next pixel(s) in the frame of the media asset. For example, the media guidance application may analyze one or more pixels in defined sampling groups (e.g., each sampling may include a particular number of pixels). In some embodiments, each sampling group may be analyzed by the media guidance application in consecutive iterations of process 700, until all pixels in the frame, frames, and/or media asset are analyzed.

At step 706, the media guidance application determines the chrominance value(s) of the pixel(s) in the frame. For example, the media guidance application may apply image processing as described above to determine the particular chrominance value of each pixel currently being analyzed.

At step 708, the media guidance application adds one to the pixel count of pixels in the media asset corresponding to the determined chrominance value(s). For example, the media guidance application may track each chrominance value that appears in any pixel in one or more frames in the media asset. For example, in some embodiments, each instance of a particular chrominance value in a pixel of the media asset results in the addition of an instance to an overall pixel counter that corresponds to the particular chrominance value. After all pixels in the media asset have been analyzed, the media guidance application may compare the totals of each particular pixel count to perform proportional analysis or develop descriptive statistics regarding the chrominance of the media asset.

At step 710, the media guidance application determines the luma value(s) of the pixel(s) in the frame. For example, the media guidance application may apply image processing as described above to determine the particular luma value of each pixel currently being analyzed.

At step 712, the media guidance application adds the determined luma value to the total media asset luma value and the frame luma value. For example, the media guidance application may track the luma value that appears in any pixel in one or more frames in the media asset. After all pixels in the media asset have been analyzed, the media guidance application may compare the luma values of each particular pixel count to perform proportional analysis or develop descriptive statistics regarding the chrominance of the media asset. For example, the media guidance application may determine an average luma value for the media asset or may compare information associated with the luma value(s) of one frame to another frame to determine the amount of sharp luma value changes (e.g., indicating an explosion or flashing lights, which may be relevant to whether or not the media guidance application recommends the media asset as described above and below).

At step 714, the media guidance application determines whether or not there are additional pixels in the frame. If there are additional pixels in the frame, the media guidance returns to step 704. If there are not additional pixels in the frame, the media guidance application proceeds to step 716. At step 716, the media guidance application determines whether or not there are any additional frames in the media asset. If so, the media guidance application proceeds to step 718. At step 718, the media guidance application increments the frame number and returns to step 702. If not, the media guidance application determines the visual attributes associated with media asset as discussed in relation to FIGS. 1, 5A, 5B, 6A, and 6B above based on the counts of the various visual attributes at step 720.

FIG. 8 is a flowchart of illustrative steps for determining whether or not to recommend a media asset to a user based on a comparison of visual attributes of a media asset and the visual preferences of a user in accordance with some embodiments of the disclosure. Process 800 describes steps taken by the media guidance application to determine whether or not to recommend a media asset based on a comparison of the visual attributes of the media asset and the visual preferences of the user. For example, process 800 may be invoked after a selection of color analysis option 254 (FIG. 2) by a user.

It should be noted that the equipment or devices as shown and described in relation to FIGS. 3-4 may be used to perform any step in process 800. For example, in some embodiments, the media guidance application may be located on user equipment 402, 404, and 406 (FIG. 4), media content source 416 (FIG. 4), media guidance data source 418 (FIG. 4) and/or any device accessible via communications network 414 (FIG. 4), and the media guidance application may instruct the equipment or devices using processing circuitry (e.g., processing circuitry 306 (FIG. 3)). Furthermore, it is contemplated that the steps or descriptions of FIG. 8 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

At step 802, the media guidance application determines an array of visual attributes of a media asset. For example, the media guidance application may determine the visual attributes by accessing array 550 (FIG. 5) or may determine the visual attributes by processing the media asset according to process 700 (FIG. 7). In some embodiments, the array of visual attributes of the media asset may have been generated (e.g., from information transmitted in metadata accompanying the media asset and/or as described in relation to FIG. 7), received (e.g., from a remote server), and/or stored (either locally or remotely) by the media guidance application. For example, the array of visual attributes of the media asset may indicate that the three colors that predominate the media asset and the average brightness of the media asset.

At step 804, the media guidance application retrieves a visual preferences array. The visual preferences array may be a user profile containing the visual preferences for one or more visual attributes that is preferred by a user. In some embodiments, the visual preferences may be retrieved from a storage device. In some embodiments, the visual preferences array may have been generated (e.g., from information transmitted in metadata accompanying the media asset, in which the user either actively or passively indicated a preference for), received (e.g., from a remote server), and/or stored (either locally or remotely) by the media guidance application. The visual preferences array and/or the user profile may include data fields corresponding to the data fields of an array of visual attributes (e.g., as discussed in relation to FIG. 5B above). For example, the visual preferences array may indicate the three favorite colors, or all of the favorite colors, (with respect to media assets) of the user.

At step 806, the media guidance application retrieves a value in the next data field in each array. For example, during an initial iteration, the media guidance application may retrieve the first value in each array (e.g., data field 554 of array 550 (FIG. 5B)). On subsequent iterations, the media guidance application may retrieve a data field in the array that is commensurate with the number of iteration (e.g., retrieve the third data field, or data field 558 with respect to array 550 (FIG. 5B), on the third iteration). For example, the first data field in the array of visual attributes may describe the most frequently used color in the media asset. The corresponding first data field in the visual preferences array may describe the favorite color of the user (with respect to media assets). Additionally or alternatively, the first data field may include a list of colors that the user prefers (with respect to media assets).

At step 808, the media guidance application compares the value retrieved from the visual attributes array to the value retrieved from the visual preferences array. As described in relation to FIG. 5B, the media guidance application may use multiple ways to compare and contrast the values in the corresponding arrays. For example, the media guidance application may compare the value (e.g., the name of a color) of the first data field in the array of visual attributes (e.g., the most frequently used color in the media asset) to the value(s) of the first data field in the visual preferences array (e.g., one or more colors the user prefers with respect to media assets).

At step 810, the media guidance application determines whether or not the comparison of the value of the visual attributes array of the media asset with the value of the visual preferences array indicates that the user would be interested in the media asset. For example, if the visual attribute indicates that the media asset has a particular color palette (e.g., the media asset is dominated by a particular chrominance) based on having a particular hexadecimal value in the data field of the visual attributes array of the media asset, the same or a similar hexadecimal value in the corresponding data field of the visual preferences array may indicate the user will be interested in the media asset. For example, the media guidance application may determine whether or not the value from the visual attributes array matches, or is within a particular range of, the value(s) from the visual preferences array (e.g., using techniques described in relation to FIG. 5B).

If the value (e.g., the predominant color in the media asset) in the first data field of the visual attributes array of the media asset indicates a likelihood of a user interest (e.g., the predominant color in the media asset matches one of the favorite colors of the user as indicated by the visual preferences array), the media guidance application may recommend the media asset to the user at step 812. For example, the media guidance application may display the media asset, the name of the media asset, and/or a description of the media asset in listing 256 (FIG. 2). If the value in the visual attributes array of the media asset does not indicate a likelihood of a user interest (e.g., the values do not match), the media guidance application continues to step 814.

At step 814, the media guidance application determines whether or not there are any additional data fields in the array. If so, the media guidance application returns to step 806 and retrieves the value in the next data field in each array. If there are no more data fields in the array, the media guidance application does not recommend the media asset to the user at step 816. For example, if the media guidance application does not recommend the media asset, the media guidance application may select subsequent media assets and perform process 800 on each media asset until a media asset that may be recommended is found.

It should be noted that in some embodiments the media guidance application may combine one or more values to make a determination about whether or not a user may enjoy a particular media asset. For example, the media guidance application may base a recommendation on one or more visual attributes. For example, the media guidance application may combine information associated with the color palette, the luma values, the number of changes of a particular degree, or any other visual attribute to make a determination about whether or not a user may enjoy a particular asset. For example, the combination of multiple visual attributes may indicate that a media asset is of a particular animation style. Therefore, the media guidance application may retrieve one or more data field values and process them in relation to one or more other data fields before making a recommendation decision.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. It should also be noted, the systems and/or methods described above may be applied to, or used in accordance with, other systems and/or methods.

1. A method for recommending a media asset, comprising:
determining visual attributes associated with pixels in a frame of a media asset accessed on a user device;
retrieving visual preferences for a user from a storage device;
comparing the visual attributes associated with the media asset to the visual preferences; and
recommending the media asset to the user based at least in part on the comparison of the visual attributes to the visual preferences.

2. The method of claim 1, wherein the visual attributes comprise a chrominance value and a luma value.

3. The method of claim 1, wherein the visual attributes associated with the media asset indicate a ratio of a color displayed during the media asset to other colors displayed during the media asset.

4. The method of claim 1, wherein the visual attributes associated with the media asset indicate an average luma value associated with the media asset.

5. The method of claim 1, wherein the visual attributes associated with a media asset indicate a frequency of luma value changes between a plurality of frames of the media asset.

6. The method of claim 1, further comprising determining visual preferences based at least in part on the visual attributes associated with media assets previously viewed by the user.

7. The method of claim 1, further comprising determining a color palette of the media asset based at least in part on the visual attributes, wherein the color palette indicates a plurality of colors with the highest frequency of display in the media asset.

8. The method of claim 1, further comprising determining an animation style of the media asset based at least in part on the visual attributes.

9. The method of claim 1, further comprising determining a mood of the media asset based at least in part on the visual attributes.

10. The method of claim 1, further comprising determining a genre of the media asset based at least in part on the visual attributes.

11. A system for recommending a media asset, comprising control circuitry configured to:
determine visual attributes associated with pixels in a frame of a media asset accessed on a user device;
retrieve visual preferences for a user from a storage device;
compare the visual attributes associated with the media asset to the visual preferences; and
recommend the media asset to the user based at least in part on the comparison of the visual attributes to the visual preferences.

12. The system of claim 11, wherein the visual attributes comprise a chrominance value and a luma value.

13. The system of claim 11, wherein the visual attributes associated with the media asset indicate a ratio of a color displayed during the media asset to other colors displayed during the media asset.

14. The system of claim 11, wherein the visual attributes associated with a media asset indicate an average luma value associated with the media asset.

15. The system of claim 11, wherein the visual attributes associated with a media asset indicate a frequency of luma value changes between a plurality of frames of the media asset.

16. The system of claim 11, wherein the control circuitry is further configured to determine visual preferences based at least in part on the visual attributes associated with media assets previously viewed by the user.

17. The system of claim 11, wherein the control circuitry is further configured to determine a color palette of the media asset based at least in part on the visual attributes, wherein the color palette indicates a plurality of colors with the highest frequency of display in the media asset.

18. The system of claim 11, wherein the control circuitry is further configured to determine an animation style of the media asset based at least in part on the visual attributes.

19. The system of claim 11, wherein the control circuitry is further configured to determine a mood of the media asset based at least in part on the visual attributes.

20. The system of claim 11, wherein the control circuitry is further configured to determine a genre of the media asset based at least in part on the visual attributes.

21-30. (canceled)
